(19) United States
(12) Patent Application Publication
(10) Pub. No.: US 2012/0136598 A1
(43) Pub. Date: May 31, 2012

(54) Optimization of Decoupling Device Choice for Electronic Design

(76) Inventor: Vladimir Dmitriev-Zdorov, Longmont, CO (US)

(21) Appl. No.: 13/198,687

(22) Filed: Aug. 4, 2011

Related U.S. Application Data
(60) Provisional application No. 61/370,733, filed on Aug. 4, 2010.

(51) Int. Cl. G06F 19/00

(52) U.S. Cl. 702/65

(57) ABSTRACT

Optimization of decoupling design selection for electronic designs is described. Initially an electronic design, such as, a printed circuit board, having a power delivery network with a given impedance value is identified. A target impedance value for the power delivery network is also identified. Subsequently, a decoupling impedance value, that, if added to the impedance of the power delivery network would transform the given impedance value into the target impedance value, is derived. In many implementations, the power delivery network may have a number of ports. Accordingly, a decoupling impedance value may be derived for each port. A selection of decoupling devices, each having a given impedance value, are also identified. Subsequently, a system of equations is formed that relates the decoupling devices and their associated impedance values to the decoupling impedance values. The system of equations is then solved to derive a subset of the decoupling devices that, if added to the power delivery network, would transform the given impedance of the power delivery network into the target impedance.

### REFERENCE TO RELATED APPLICATIONS

This application claims priority under 35 U.S.C. §119 to U.S. Provisional Patent Application No. 61/370,733, entitled “Decoupling Capacitor Choice Optimization,” filed Aug. 4, 2010 and naming Vladimir Dmitriev-Zdorov as the sole inventor, which application is incorporated entirely herein by reference.

### FIELD OF THE INVENTION

The present invention is directed towards printed circuit board design. More specifically, various implementations of the invention are directed towards decoupling the power supply network of a printed circuit board from the other components on the board.

### BACKGROUND OF THE INVENTION

Integrated circuit devices are used in a wide variety of modern appliances, such as computers, automobiles, telephones, televisions, manufacturing tools, satellites, and even toys. While even a small integrated circuit device can provide a great deal of functionality, almost every integrated circuit device must be electrically connected to an input or output device, to another integrated circuit device, or to some other electronic component in order to be useful. To provide these electrical connections, integrated circuit devices are typically mounted on a printed circuit board (PCB). Most PCBs have a rigid, planar core. The core may be formed, for example, of a sheet of fiberglass material impregnated with epoxy. Conductive lines or “traces” then are formed on one or both surfaces of the core to electronically connect the components attached to the PCB.

A PCB can include “active” components, such as, for example, field programmable gate arrays (FPGAs), integrated circuits, and application-specific integrated circuits (ASICs). Additionally, a PCB can also include “passive” components, such as, for example, resistors, capacitors, and inductors. Many PCB designs include components that serve to provide or “deliver” power to the other components on the PCB. These power delivery components are often referred to as a “power delivery network” or a “power supply.” The other components on the PCB are often referred to as loads.

An important consideration in the design and operation of power supplies is how the power supply interacts, electrically, with the loads. As those of ordinary skill in the art will appreciate, various electrical effects can cause degradation or “noise” within the power supply signals, such as, for example, fluctuations in the voltage levels. In some cases, one load may introduce noise into the power supply network while another load is subjected to that noise. For example, when one load begins to draw power or stops drawing power from the power supply, spikes in the voltage supply levels may be created, which spikes will be manifest on the power supply lines connected to another load.

One method that designers use to suppress power supply noise is to ensure that the power supply is electrically decoupled from the loads. More specifically, the mutual and self-impedance of the power supply network is ideally kept below some threshold level. Decoupling is typically realized by adding capacitors between the power supply and the loads, to “buffer,” in essence, the power supply from the switching activity of the loads.

Conventionally, the number and size of the capacitors to add to the power supply network is determined heuristically, often with the aid of some computing platform on which to execute the heuristics. In some cases, the heuristics run without simulating the PCB design. Such cases often result in a greater number and sizing of capacitors than are actually needed to decouple the power supply and the loads. As a result, the costs associated with manufacturing the PCB increase unnecessarily. With other cases, the heuristics run while simulating the PCB design. As those of ordinary skill in the art will appreciate, a great variation in the type, parameters, and placement of capacitors must be considered during the heuristic process. Accordingly, the simulation processes associated with the heuristic selection of these capacitors require a large amount of computing resources and time to execute the simulation based on these different options.

### BRIEF SUMMARY OF THE INVENTION

Various implementations of the invention provide for the determination of devices necessary for decoupling a PCB power supply from the rest of the PCB.

In various implementations, a PCB design having a power delivery network with a given impedance value is identified. A target impedance value for the power delivery network is also identified. Subsequently, a decoupling impedance value, that, if added to the impedance of the power delivery network would transform the given impedance value into the target impedance value, is derived. In many implementations, the power delivery network may have a number of ports. Accordingly, a decoupling impedance value may be derived for each port. A selection of decoupling devices, each having a given impedance value, are also identified. Subsequently, a system of equations is formed that relates the decoupling devices and their associated impedance values to the decoupling impedance values. The system of equations is then solved to derive a subset of the decoupling devices that, if added to the power delivery network, would transform the given impedance of the power delivery network into the target impedance.

With various implementations, the system of equations may be solved for a given set of frequencies. Decoupling impedance values may be derived for all frequencies in the set of frequencies. Subsequently, a system of equations, as described above, may be formed for each frequency in the set of frequencies. Then, a minimization of these systems of equations may be performed to derive a subset of the decoupling devices applicable to the set of frequencies.

With some implementations, the decoupling devices may be attached a distance away from the ports of the power delivery network. In these implementations, the decoupling impedance values may be derived based in part upon a series impedance value, a parallel impedance value, and a set of calibration parameters.

These and additional implementations of invention will be further understood from the following detailed disclosure of illustrative embodiments.

### BRIEF DESCRIPTION OF THE DRAWINGS

The present invention will be described by way of illustrative implementations shown in the accompanying drawings in which like references denote similar elements, and in which:

FIG. 1 illustrates a computing device.

FIG. 2 illustrates a conventional printed circuit board design.

FIG. 3 illustrates a method that may be implemented according to various implementations of the present invention.

FIG. 4 illustrates an iterative method that may be implemented according to various implementations of the present invention.

FIG. 5 illustrates a network with a decoupling device placed between two ports.

FIG. 6A illustrates the network of FIG. 5 in alternate detail.

FIG. 6B illustrates a schematic representation of the network of FIG. 5.

FIG. 6C illustrates the schematic of FIG. 6B with modified connections.

FIG. 7 illustrates a network having a port and multiple decoupling devices.

FIG. 8 illustrates a directly connected multi-port network.

FIG. 9 illustrates a mixed connection multi-port network.

FIG. 10 illustrates a tool that may be provided by various implementations of the present invention.

### DETAILED DESCRIPTION OF THE INVENTION

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed implementations. Such terms are often high-level abstractions of the actual operations that are performed. The actual operations that correspond to these terms will often vary depending on the particular implementation.

Some of the methods described herein can be implemented by software stored on a computer-readable storage medium, which may subsequently be accessed and executed on a computer. Accordingly, some of the disclosed methods may be implemented as part of a computer implemented electronic design automation (“EDA”) tool. The selected methods could be executed on a single computer or a computer networked with another computer or computers.

### Illustrative Operating Environment

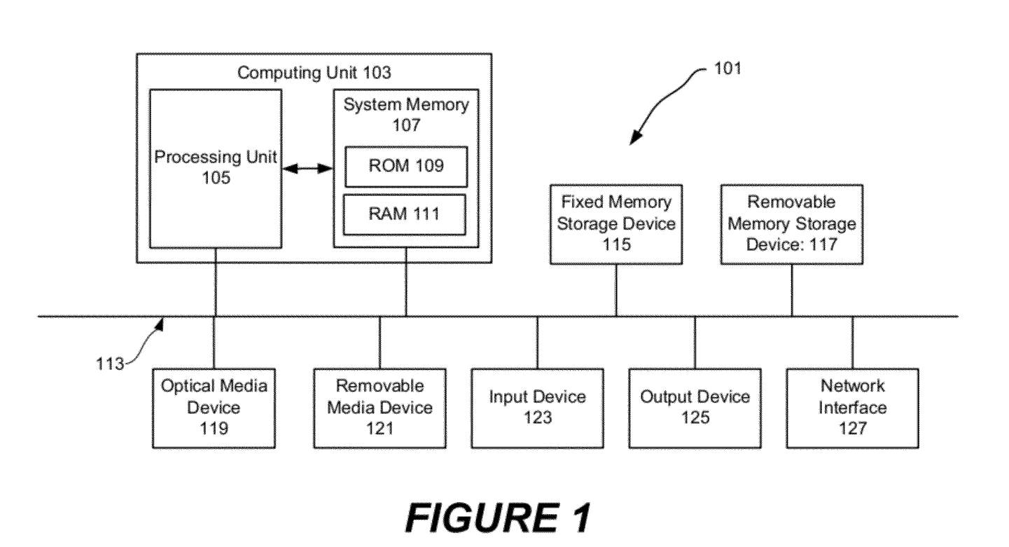

As the techniques of the present invention may be implemented using software instructions, the components and operation of a computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

As stated above, various embodiments of the invention may be implemented using software instructions. These software instructions may be stored on one or more computer readable devices, such as, for example, the system memory 107, or an optical disk for use in the optical media device 119. As those of ordinary skill in the art will appreciate, software instructions stored in the manner described herein are inherently non-transitory in nature. Additionally, some implementations of the invention describe outputting operations. With various implementations, these operations describe saving a result to a computer-readable storage device or a computer-readable storage medium. In various implementations, these operations describe displaying the result via a display device. With some implementations, the result may be output by sending the result to a printing device to be printed on a physical media.

### Decoupling Device Selection

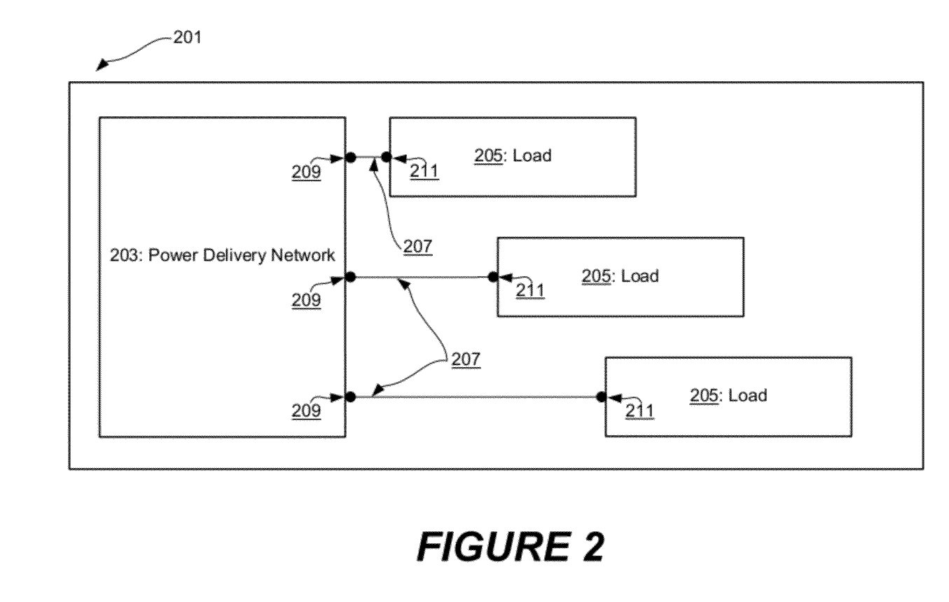

FIG. 2 illustrates a printed circuit board design 201 having a power delivery network 203 and loads 205. As can be seen from this figure, the power delivery network 203 is connected to the loads 205 through various power signal lines 207. The power signal lines 207 are connected to the power delivery network 203 and the loads 205 at what is often referred to as “ports.” For example, ports 209 are shown on the power delivery network 203 and ports 211 are shown on the loads 205. As those of ordinary skill in the art will appreciate, the power signal lines 207 electrically connect the power delivery network 203 to the loads 205, allowing electrical current, or power, to be conveyed from the power delivery network 203 to the loads 205. Often, the amount of power supplied to each load 205 can vary. For example, a first load can be supplied a first quantity of power and a second load supplied a second, different, quantity of power. Additionally, some loads may be supplied power while other loads are not supplied power. More specifically, some loads may be on, while other loads are off.

As stated above, and as those of ordinary skill in the art will appreciate, various electrical effects can cause degradation or “noise” manifested in the power signal lines 207. One example of this is power supply switching noise. This types of noise occurs where a first one of the loads 205 is being supplied power from the power delivery network 203 and another of the loads 205 begins to draw power from, or alternatively, stops drawing power from the power delivery network 203. When this occurs, a temporary surge or sag (i.e., an increase or reduction) in the amount of power supplied to the first load 205 is often reflected in the voltage level of the power signal lines 207 connecting the power delivery network 203 and that particular load 205.

As further described above, noise resulting from power supply switching activity, as well as other electrical effects, can be mitigated by decoupling the loads 205 from the power delivery network 203. Decoupling is often realized by maintaining the mutual and self-impedance of the power delivery network 203 below a threshold level. Causing the mutual and self-impedance of the power delivery network 203 to be below this threshold level is often realized by adding capacitors, or other types of decoupling devices, such as, for example, an inductor-capacitor circuit (conventionally referred to as an “LC Network”) between the power delivery network 203 and the loads 205. In some implementations, the decoupling devices are placed at the ports 209. In other cases, the decoupling devices are placed somewhere between the ports 209 and the ports 211.

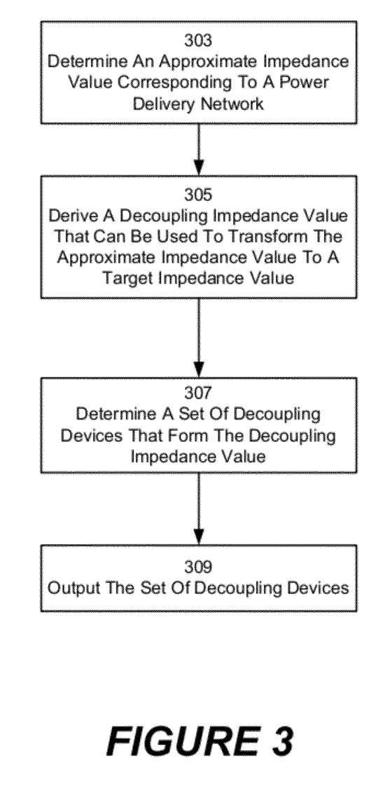

FIG. 3 illustrates a method 301 that may be applied by various implementations of the invention to determine a set of decoupling devices that can be used to decouple a power delivery network from a load. Although reference herein is made to decoupling a power delivery network and a load represented in a printed circuit board design, various implementations of the invention may be applied to decoupling power delivery networks and loads represented in other electronic designs, such as, for example, System-on-Chip integrated circuit designs.

As can be seen from this figure, the method 301 includes an operation 303 for determining an approximate impedance value corresponding to a power delivery network 203. As those of ordinary skill in the art will appreciate, an electrical circuit or “network” has a number of different electrical characteristics. One such characteristic is the impedance. The impedance of a network quantifies the opposition that the network presents to the flow of alternating current. In various implementations of the invention, the approximate impedance value will be provided by a user of the method 301. As such, the operation 303 may determine the approximate impedance value of the power delivery network by referencing the value provided by the user. In other implementations, the approximate impedance value may be determined by simulating the characteristics of the printed circuit board design and subsequently determining the approximate impedance from the simulation. With further implementations, a separate impedance value may be determined for each port 209 of the power delivery network 203.

As those or ordinary skill in the art will appreciate, impedance is defined in the frequency domain. More specifically, impedance is represented with respect to the frequency at which the current or voltage changes polarity, as opposed to some other measure, such as, for example time. Accordingly, a specific impedance value will corresponds to a specific frequency. As such, the impedance values may be represented as a function of frequency, or as discretely sampled points corresponding to selected frequencies. Those of ordinary skill in the art will appreciate that transformation from a continuous representation of impedance to a discrete representation is possible, using, for example, a Fourier transform. Furthermore, those of ordinary skill in the art will appreciate, that the characteristics of the power delivery network 203 may be described in any number of suitable multiport parameters, such as, for example, Z parameters, S parameters, or Y parameters.

Although various implementations of the invention may be applied to either a continuous representation of impedance or discrete implementations, the following description assumes the representation is discrete. With various implementations, the sampling points of the discrete representation are taken sufficiently close together such that the majority of the resonance points of the impedance values are captured in the sampled frequencies. In the description below, Z_{PDN}(f) will be used to denote the impedance of the power delivery network for a given frequency f and Y_{PDN}(f) will be used to denote the admittance (i.e. the inverse of impedance) for a given frequency. As stated above, as impedance is often measured for each port 209 of the power delivery network 203 Z_{PDN} will often be a complex matrix of size N×N, where the power delivery network 203 has N ports 209.

The method 301 further includes an operation 305 for deriving a decoupling impedance value, which, when combined with the approximate impedance value, transforms the approximate impedance value into a target impedance value. In the description below, the target impedance value may be denoted by Z_{T}(f) and the decoupling impedance value by Z_{PDN}_{_{—}}_{MOD}(f). As stated above, it is often desirable to maintain the impedance of a power delivery network below some threshold value. The target impedance value represents this threshold impedance value. In some implementations, the target impedance value will be a constant, such as, for example, 1e-3Ω. In other implementations, the target impedance may be either a continuous function or a set of discretely sampled values. Typically, the discrete representation is sampled at the same frequencies as the approximate impedance. Furthermore, as those of ordinary skill in the art will appreciate, the target impedance should ideally be non-zero, as an impedance of zero is not practically achievable.

Subsequently, the method 301 provides an operation 307 for determining a set of decoupling devices that form the decoupling impedance value. In various implementations, the set of decoupling devices will be selected from a set of devices, which are available for inclusion into the printed circuit board design, for use as decoupling devices. As stated above, various devices, such as, for example, capacitors may be added to the printed circuit board design 201 to effectively decouple the power delivery network 203 from the loads 205. As those of ordinary skill in the art will appreciate, each device in the set of devices has its own impedance value. The description below may denote the impedance of a particular device as Z_{DD}_{_{—}}ₘ(f), where m is a particular decoupling device selected from the set of available devices.

The method 301 also includes an operation 309 for outputting the set of decoupling devices. In various implementations, the operation 309 may save the set of decoupling devices to a computer-readable storage device or a computer-readable storage medium. With other implementations, the operation 309 may display the set of decoupling devices for a user of the method 301 via a display device. With some implementations, the operation 309 may send the set of decoupling devices to a printing device to be printed on a physical media. With further implementations, the operation 309 may modify the printed circuit board design to include the set of decoupling devices.

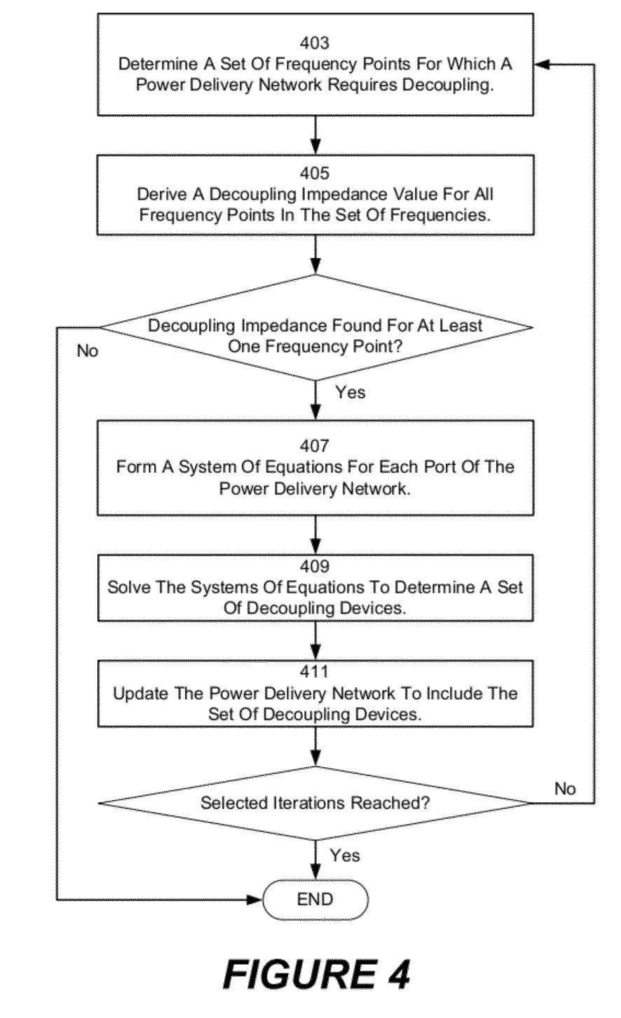

With various implementations, the method 301 shown in FIG. 3 can be run in an iterative fashion in order to optimize the determination of the set of decoupling devices. FIG. 4 illustrates an optimization method 401 according to some implementations of the invention. As those of skill in the art will appreciate, some operations of the method 401 are similar to the operations of the method 301 described above, and reference to that description is given here. As can be seen from this figure, the method 401 includes an operation 403 for determining a set of frequency points for which a power delivery network 203 requires decoupling. As stated above, impedance is defined with respect to frequency. In the description of the illustrative implementations below, discussion is given on how to determine a set of frequency points for which a power delivery network needs decoupling.

The method 401 also includes an operation 405 for deriving a decoupling impedance value for all frequency points in the set of frequency points. As can be seen from this figure, if decoupling impedance is not found for any frequencies, then the method ends. However, if a decoupling impedance is found for at least one frequency in the set of frequencies, then an operation 407 for forming a system of equations for each port of the power delivery network 203 is provided. In the description of the illustrative implementations below, discussion is given on how to form a system of equations that relates the decoupling impedance to a set of available devices is discussed. Subsequently, an operation 409 for solving the system of equations to determine a set of decoupling devices and an operation 411 for updating the power delivery network 203 to include the set of decoupling devices. As can be further seen from this figure, the operations 403 through 411 may be repeated a number of times until either a decoupling impedance is not found for any frequencies in the set of frequencies as stated above or a set number of iterations has been completed.

Illustrative Implementation with Decoupling Device Placement at the Power Delivery Network Ports

In various implementations of the invention, the decoupling devices may be placed at the ports 209. As such, the decoupling impedance can be represented by the following equation. Where Yₑₓₜᵣₐ(f) denotes an extra admittance, which if added to the power delivery network in parallel causes the impedance of the power delivery network 203 (e.g. the approximate impedance) to equal the target impedance.

Z_{PDN}_{_{—}}_{MOD}(f)=[Z_{PDN}⁻¹(f)+Yₑₓₜᵣₐ(f)]⁻¹ (1)

With various implementations, it may be advantageous to convert the multiport parameters of the power delivery network 203 into the Y parameter form for every given frequency. In some cases it will not be possible to convert the parameters of the power delivery network 203 into the Y parameter form. With other cases, the Y parameters may not exist. In these cases, this may indicate that the diagonal terms of the Y parameter matrix, the off-diagonal terms, or both, have a value that is not limited. More specifically, one of the values may go to infinity. In practice, this may happen when, for example, a lumped system is investigated as a distributed system. Consequently, the system will contain groups of electrically connected and, as a result, redundant ports. In cases such as this, every such group may be reduced to a single port.

In some implementations, the values of the Y parameter matrix may indicate a large self-conductance of some ports, such as, for example, due to series resonances. In many cases this is a desirable property as a large self-conductance often translates into a small self-impedance.

As detailed above, with various implementations of the invention, a set of decoupling devices may be derived from a set of available devices. This derived set of decoupling devices can then be added to the power delivery network 203 to make the resulting power delivery network parameters match the defined target impedance profile. As used herein, this implies that the impedance of the power delivery network 203 is to be within some threshold level of the target impedance, and need not necessarily have the exact target impedance values.

As the decoupling devices are externally connected to the ports 209 of the power delivery network 203 in this illustrative example, their admittances sum up with the diagonals of the admittance matrix of the power delivery network 203. Adding the decoupling devices to the power delivery network 203 does not change the mutual admittance (i.e. the off-diagonal entries of the matrix Y_{PDN}(f)) of the power delivery network 203.

With some implementations, derivation of the set of decoupling devices may be facilitated by taking advantage of the fact that the mutual impedance z_{i,j} of the power delivery network 203, by its absolute value, is practically always smaller than the absolute values of the respected diagonal or self-impedance terms. This fact is represented by the following equation.

|z_{pdn}_{_{—}}_{i,j}|<max(|z_{pdn}_{_{—}}_{i,i}|,|z_{pdn}_{_{—}}_{j,j}|) (2)

Even where Equation (2) is not true for non-decoupled power delivery networks, it becomes true when decoupling devices are attached to the power delivery network. As a result of this, the number of matrix parameters that need to be considered to derive the set of decoupling devices is reduced to N diagonals only.

### Derivation of the Decoupling Impedance

As detailed above, in order to determine the set of decoupling devices, a decoupling impedance value is first derived. Often, this decoupling impedance is represented as admittance and denoted by Yₑₓₜᵣₐ(f). With some implementations, this extra admittance may be constructed from external single port devices (i.e. decoupling devices,) which are directly connected to the ports 209 of the power delivery network 203. As a result, Yₑₓₜᵣₐ is a diagonal matrix and the impedance of the modified power delivery network is represented by Equation (1) above.

With various implementations, the decoupling impedance value may be determined by first deriving the case where the diagonal entries of the modified impedance matrix equal the target impedance. As mentioned above, with respect to Equation (2), this forces the off-diagonal values to be smaller than the target level. In some implementations, this is achieved by letting the diagonals in Equation (2) equal Z_{T}(f). As a result, Equation (2) can be transformed into the following.

diag{[Z_{PDN}⁻¹(f)+Yₑₓₜᵣₐ(f)]⁻¹}=diag{Z_{T}(f)} (3)

Subsequently, a system of N equations with N unknowns Yₑₓₜᵣₐ_{_{—}}_{i,i}(fₖ) i=1 . . . N may be formed for every fixed frequency fₖ based on Equation (3). For example, for the case where N=1, Equation (3) yields the following.

Yₑₓₜᵣₐ(fₖ)=Y_{T}(fₖ)−1/Z_{PDN}(fₖ) (4)

As can be seen from Equation (4), a solution to the system of equations will always exist and remain causal provided that the target impedance and the parameters of the power delivery network 203 also remain causal. However, the required admittance necessary to cause the impedance of the power delivery network 203 to fall below the target impedance may become non-passive if the resistive component of the admittance of the power delivery network 203 is larger than that of the target admittance. In practice, this implies that the power delivery network 203 already has sufficiently low impedance. More specifically, the impedance of the power delivery network 203 (i.e. the approximate impedance) is already lower than the target impedance. As a result, no decoupling is necessary and the set of decoupling devices will be empty.

Where the power delivery network 203 includes multiple ports 209, the system of equations formed based on Equation (3) above becomes non-linear in terms of the unknown extra admittances. This results from the fact that the left side of the equation involves the inversion of fully populated impedance matrices. In various implementations, the resulting system of equations could be solved, by, for example, application of the iterative Newton's method, or some other iterative approach. Those of ordinary skill in the art will appreciate how these iterative approaches may be implemented. As such, a further discussion of them will not be made.

As those of ordinary skill in the art will also appreciate, nonlinear equations will occasionally not have any solutions. Alternatively, a system of nonlinear equations may have multiple solutions. However, a useful observation of Equation (3) is that solutions remain well-defined where Z_{PDN}(fₖ) is larger, by module, than the target impedance. As a result, Yₑₓₜᵣₐ(fₖ) tends to be sufficiently larger than 1/Z_{PDN}(fₖ) and the sum matrix stays close to diagonal making the system of equations to be solved less coupled and close to ‘linear’.

In various implementations, where the system of equations are easily solved and produce physically meaningful passive admittance Yₑₓₜᵣₐ(fₖ), it is assumed the decoupling is indeed necessary. Conversely, where numerical difficulties in solving the system of equations are found, such as, for example, non-convergence of Newton iterations, it may be assumed that that decoupling for this particular frequency is not needed. As such, with some implementations, solving the system of equations for that frequency is skipped.

### Derivation of the Set of Decoupling Devices

Given the decoupling impedance values, which as stated, are often represented as admittance values Yₑₓₜᵣₐ_{_{—}}_{i,i}(fₖ), i=1 . . . N for a collection of frequency ports, a set of decoupling devices that implements the decoupling impedance can be derived. It is important to note that deriving the decoupling impedance involved solving a system of equations separately for every frequency point but simultaneously for all N ports.

Deriving a set of decoupling devices that approximates this decoupling impedance (i.e. the extra admittance Yₑₓₜᵣₐ_{_{—}}_{i,i}(f)) can be made separately for every port as they form a diagonal matrix. However, the derivation should be done for all frequency points where decoupling is needed (i.e. where Yₑₓₜᵣₐ_{_{—}}_{i,i}(f) is defined.) In some implementations, all other frequency points are ignored. This follows from the fact that once the impedance of the power delivery network 203 was low enough at those particular frequencies, it will likely remain low after a decoupling device(s) is added due to the conditions at other frequencies. Accordingly, the following equation can be considered for every port i and all frequencies, k=1 . . . K.

$${\sum }_{m = 1}^{M} {x}_{m} {Y}_{DD\_m} ( {f}_{k} ) = {Y}_{extra\_i , i} ( {f}_{k} ) \qquad ( 5 )$$

Given Equation (5), if it is assumed that there are M different types of decoupling devices, with xₘ unknown amounts of every device type, and where K is a number of considered frequency points, the equation becomes a system of K linear equations in M unknowns,

AX=B. (6)

In Equation (6), A is a K×M complex value matrix constructed from samples of admittances or decoupling devices: A_{k,m}=Y_{DD}_{_{—}}ₘ(fₖ), X is a vector of M unknowns, and B is a vector of K samples of the desired ‘extra’ admittance: Bₖ=Yₑₓₜᵣₐ_{_{—}}_{i,i}(fₖ), k=1 . . . K. Since X should never be complex, it is convenient to reformulate Equation (6) by equating real and imaginary parts of (6), resulting in the following equation.

$$[ \begin{matrix}real ( A ) \\ imag ( A )\end{matrix} ] X = [ \begin{matrix}real ( B ) \\ imag ( B )\end{matrix} ] \qquad ( 7 )$$

In Equation (7), the matrix of linear systems becomes of size 2K×M and the right hand vector's size 2K. The number of unknowns, now real, remains the same. As those of ordinary skill in the art will appreciate, Equation (7) cannot be solved exactly for several reasons. First, the number of frequency samples as a rule is much greater than the number of different decoupling devices. As a result, finding a vector X that minimizes the norm of (AX−B) while being itself of a reasonably small norm is difficult. In some implementations, a solution to Equation (7) may be found by application of singular value decomposition (SVD) or triangular-orthogonal (QR) decomposition or other similar methods applicable to systems with rectangular matrices. As those of ordinary skill in the art will appreciate how to apply such methods, they are not further discussed herein.

Another difficulty stems from the nature of the desired solution. It is expected that the numbers xₘ, m=1 . . . M should be integer and non-negative, as they show the number or decoupling devices. Of course, this is not the case when (7) is solved by standard SVD or QR procedures. There are several ways to overcome the problem. For example, if the proposed number for m-th decoupling device is negative, this device is excluded from consideration, the respected column is removed from the matrix in (7) and the system is solved again. This procedure is repeated until all coefficients become non-negative. If all devices were excluded but a non-negative solution was not reached, it may be concluded that no decoupling is necessary. This may be due to the target impedance level being reached or even crossed during the optimization. Alternatively, a solution may not be possible using the given set of available devices. The resulted non-negative values can then be rounded up to the nearest integer number and the decoupling devices corresponding to these integers selected as the set of decoupling devices.

It is important to note that when reference is made herein to either a decoupling device or the set of decoupling devices it may indicate either the range or all devices available for selection as a decoupling device or the selected set of devices to be used to achieve the desired target impedance level. Those of ordinary skill in the art will be able to distinguish between these references based upon the context.

In some implementations, negative numbers can be used to find a valid solution. For example, given a power delivery network that already has already been decoupled by a set of decoupling devices, and the approximate impedance Z_{PDN}(f) already includes the effect from these decoupling devices. Negative numbers found from Equations (6) or (7) above may be taken to indicate that the number of capacitors of certain types already connected to the power delivery network as decoupling devices can be reduced.

With various implementations, a limit to the maximal number of decoupling devices of a certain type may be set. For example, if capacitors of type m are more expensive than others, an upper limit for their number (e.g. \tilde{x}ₘ<Xₘₐₓ_{_{—}}ₘ, per port or total) may be set. If the limit is exceeded when solving (7), the accepted number is truncated, and this type can be excluded from consideration on the next iterations. Another case when the number of devices should be limited is when this particular capacitor type produces only minor effect on the impedance profile and therefore formally applied mathematical procedures propose unrealistically large numbers of such capacitors. This effect is known when solving system of equations with small singular numbers. Here, a similar approach to that used with negative numbers can be followed. Particularly, this type of capacitor can be excluded from consideration, Equations (7) can then be reformulated and solve again.

Once a set of decoupling devices is determined, the actually added conductance can be represented by the following equation.

$${Y}_{extra\_i , i\_actual} ( {f}_{k} ) = {\sum }_{m = 1}^{M} {\tilde{x}}_{m} {Y}_{DD\_m} ( {f}_{k} ) \qquad ( 8 )$$

Then, from N separate entries (i,i) given by Equation (8), diagonal matrix Yₑₓₜᵣₐ_{_{—}}_{actual}, similar to Equation (2) can be formed.

Z_{PDN}_{_{—}}_{mod}(f)=[Z_{PDN}⁻¹(f)+Yₑₓₜᵣₐ_{_{—}}_{actual}(f)]⁻¹ (9)

Illustrative Implementation with Decoupling Device Placement a Selected Distance from the Power Delivery Network Ports

With some implementations, the decoupling devices can be placed a distance away from the ports 209 shown in FIG. 2 as opposed to directly at the ports 209. As the decoupling devices are not placed at the locations where the impedance of the power delivery network is measured, considerable complications to the process of deriving the set of decoupling devices are encountered. Those of ordinary skill in the art will appreciate these complications.

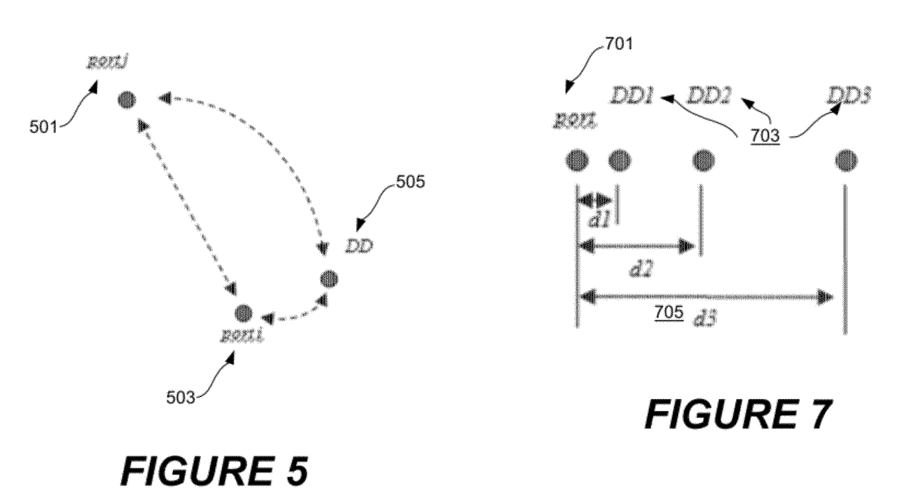

One complications is that the impedance from any particular decoupling device can no longer be attributed to a single port as the effects of a single decoupling device upon the impedance of the power delivery network are shared between ports. More specifically, the contribution from the conductance of a decoupling device placed in the vicinity of a single port not only effects the diagonal component of Yₑₓₜᵣₐ_{_{—}}_{i,i}(f), but its effects can be seen at other ports. In general, the matrix of extra conductance is no longer diagonal. This is illustrated in FIG. 5. A first port 501 and a second port 503, having current sources attached to them, along with a decoupling device 505, are shown.

As those of ordinary skill in the art will appreciate, the ports 501 and 503 imitate the currents consumed by power ports of other active device near the ports. Specifically, these currents pass through decoupling devices. If a decoupling device were connected directly to port 503, and the current injected only at port 501, then, the portion of this current that reaches the decoupling device would come through port 503 as well, and therefore the exact impedance of the path between port 501 and the decoupling device would be taken into account by the multiport impedance matrix as detailed above. However, when the decoupling device is moved away from the port, as shown by the decoupling device 505, new current paths appear allowing the current from port 501 to reach the decoupling device 505 without ‘visiting’ port 503. Such ‘undetected’ paths create off-diagonal entries in the “extra” admittance matrix that are difficult to predict without detailed analysis of the entire power delivery network geometry.

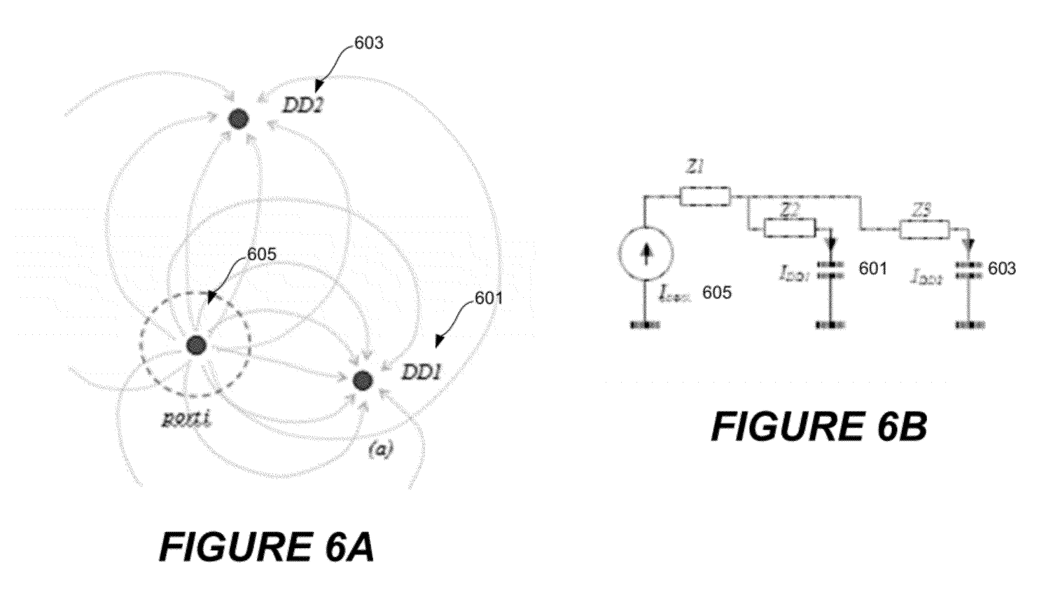

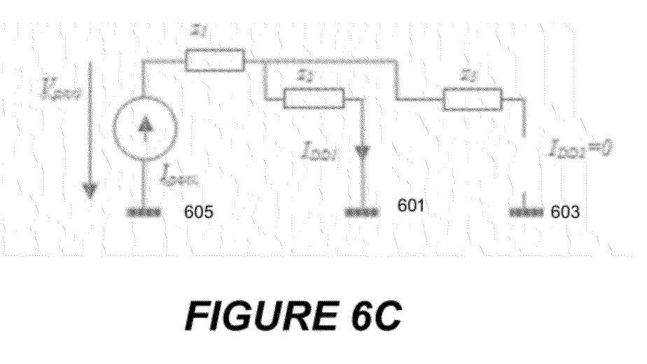

Another complication is that the effects from two or more decoupling devices placed in the vicinity of a certain port are no longer additive. More specifically, these decoupling devices cannot be considered as connected in parallel. This is illustrated in FIG. 6A. This figure shows the case of two decoupling devices 601 and 603 located near a port 605. The current density lines 607 showing the current through the decoupling device 601 (yellow) and 603 (cyan) indicate that within a small contact area around the port 605 (shown by red circle), both currents have a shared path of a certain impedance where the voltage drops add up and therefore connection cannot be considered ‘parallel’. Only at a larger distance from the port, the currents essentially split and can be considered as being in parallel paths. Approximately, we can represent this by the schematic shown in FIG. 6B, the common portion has impedance z₁, connected with the port 605 in series, and the two parallel impedances represent independent paths.

### Determination of Calibration Parameters

To some extent, the effects of placement of decoupling devices a distance away from a port 209 can be accounted for by means of additional measurement data, often available when analyzing power delivery networks 203. As used herein, this additional measurement data is referred to as “calibration parameters” and can be in the form of S, Z or Y parameters.

For example, by using a field solver or some other types of element solver, N+1 port Z-parameters for a port 209 and N decoupling ports, as shown in FIG. 7, can be created. As can be seen from this figure, a first port 701 along with decoupling devices 703, which are each a distance 705 away from the port 701 are shown. It may be advisable to follow the following rules when creating these parameters:
1. no decoupling or other devices are attached to the given ports (same as attaching decoupling devices with infinite internal impedance);
2. via types and pad sizes and other mounting-related parameters should be exactly as for the ‘actual’ decoupling port and ‘actual’ decoupling devices;
3. the distances (d1 . . . dN) are selected so as to cover most probably range of distances for the decoupling devices relative to the nearest port; and
4. when extracting calibration parameters we assume that there are no other ports on the printed circuit board and also that the PCB boundaries are father than the distances between the calibration ports.

It is acknowledged that is some cases, the calibration parameters will not be able to account for reflections from the printed circuit board boundaries, and also that decoupling effects from every separate decoupling device will not be properly shared between ports. However, the use of these calibration parameters typically allows for a more accurate prediction of the behavior.

Assuming that there is a shared component of impedance between different decoupling currents (as z₁ in FIG. 6B), and that the individual impedances (z₂, z₃) continuously depend on the distance from the port, calibration parameters allow us to extract these impedances. In various implementations, a more complex topology than that shown in FIG. 6B could be used. However, for this illustrative example, the case illustrated in FIG. 6B will be used.

As those of ordinary skill in the art will appreciate, adding or removing ports does not affect the Z-parameters for already existing ports. This follows since it is assumed that a port is excited by an ideal current source whose internal admittance is zero. Hence, in the absence of external excitation, a port does not affect parameters measured at other ports. As such, the matrix Z shown below represents 4-port Z-parameters for the system described in FIG. 7 as well as characteristics of every single port pair (port—decoupling devices) taken separately.

$$Z = [ \begin{matrix}{z}_{pp} & {z}_{p\_d 1} & {z}_{p\_d 2} & {z}_{p\_d 3} \\ {z}_{p\_d 1} & {z}_{dd 11} & {z}_{dd 12} & {z}_{dd 13} \\ {z}_{p\_d 2} & {z}_{dd 12} & {z}_{dd 22} & {z}_{dd 23} \\ {z}_{p\_d 3} & {z}_{dd 13} & {z}_{dd 23} & {z}_{dd 33}\end{matrix} ] \qquad ( 10 )$$

From Equation (10), 3 2×2 matrices characterizing the pairs: (P, D1), (P, D2) and (P, D3) can be extracted as follows:

$${Z}_{pd 1} = [ \begin{matrix}{z}_{pp} & {z}_{p\_d 1} \\ {z}_{p\_d 1} & {z}_{dd 11}\end{matrix} ] , \\ {Z}_{pd 2} = [ \begin{matrix}{z}_{pp} & {z}_{p \_ d 2} \\ {z}_{p \_ d 2} & {z}_{dd 22}\end{matrix} ] , \\ {Z}_{pd 3} = [ \begin{matrix}{z}_{pp} & {z}_{p\_d 3} \\ {z}_{p\_d 3} & {z}_{dd 33}\end{matrix} ] .$$

From every such matrix, a ‘series’ impedance that a partial decoupling current would experience when traveling from a port of the load 205 (i.e. ports 211) to a port of the power delivery network 203 (i.e. a port 209.) can be extracted.

Referring back to FIG. 6B, if the port for the decoupling device 601 were shorted to ground and port the decoupling device 603 were disconnected, as shown in FIG. 6C, the input voltage (e.g. Vₚₒᵣₜ) could be measured and divided on the decoupling current I_{dd1}. The result would be the sum of zₛₑᵣ₁=z₁+z₂. This ratio (i.e. Vₚₒᵣₜ/I_{dd1}) can be found by considering Z-parameter equations with appropriate terminal conditions, such as, for example, the following equation.

$$[ \begin{matrix}{V}_{port} \\ 0\end{matrix} ] = [ \begin{matrix}{z}_{pp} & {z}_{p\_d 1} \\ {z}_{p\_d 1} & {z}_{dd 11}\end{matrix} ] [ \begin{matrix}{I}_{port} \\ - {I}_{dd 1}\end{matrix} ] \qquad ( 11 )$$

Based on Equation (11) and the extracted matrices above, it follows that Vₚₒᵣₜ=zₚₚIₚₒᵣₜ−zₚ_{_{—}}_{d1}I_{dd1}, as a result, Iₚₒᵣₜ=(Vₚₒᵣₜ+zₚ_{_{—}}_{d1}I_{dd1})/zₚₚ. Substituting this expression into the second equation yields, 0=(zₚ_{_{—}}_{d1}/zₚₚ)(Vₚₒᵣₜ+zₚ_{_{—}}_{d1}I_{dd1})−z_{dd11}I_{dd1}. After dividing on I_{dd1} and resolving for zₛₑᵣ₁=Vₚₒᵣₜ/I_{dd1}, the following equation results.

$${z}_{ser 1} = \frac{{z}_{dd 11} {z}_{pp}}{{z}_{p\_d 1}} - {z}_{p\_d 1} \qquad ( 12 )$$

In this manner, the ‘series’ impedance for other decoupling ports can be found. For example, the series impedance for the second port is

$${z}_{ser 2} = \frac{{z}_{dd 22} {z}_{pp}}{{z}_{p\_d 2}} - {z}_{p\_d 2} .$$

Accordingly, all these impedances contain a common component equal to the shared impedance z₁ and a non-shared component that depends on the distance from the power port, which is typically known.

Those of ordinary skill in the art will appreciate that a number of different methods for separating the shared constant and the distant-dependent components exist. For example, the value of the shared impedance can be extrapolated at a zero distance. Subsequently, the distance-dependent component can be approximated by a low order (e.g. 1 of 2) polynomial φ(d) as follows:

zₛₑᵣ(d)=z_{contact}+φ(d),z_{contact}=zₛₑᵣ(0). (13)

It is important to note that the procedure for finding the shared impedance and the distance dependent impedance should be performed at every frequency point as detailed above. Furthermore, in some cases, when measuring calibration parameters with identical contact pads at the ‘power pin’ and ‘decoupling pin’, the effect from contact impedance as reflected in Equation (13) may be counted twice. As a result, half of z_{contact}=0.5zₛₑᵣ(0), or alternatively, some fraction of this value, depending on a particular geometry, can be used. After z_{contact} is found, the remaining individual impedance can be derived from the following equation.

z_{ind}=zₛₑᵣ−z_{contact}=z_{dist}+z_{cont}_{_{—}}_{dd} (14)

As can be seen, this individual part consists of the distance-dependent portion of the impedance and (optionally) the contact impedance of the decoupling device itself.

### Determination of the Decoupling Impedance

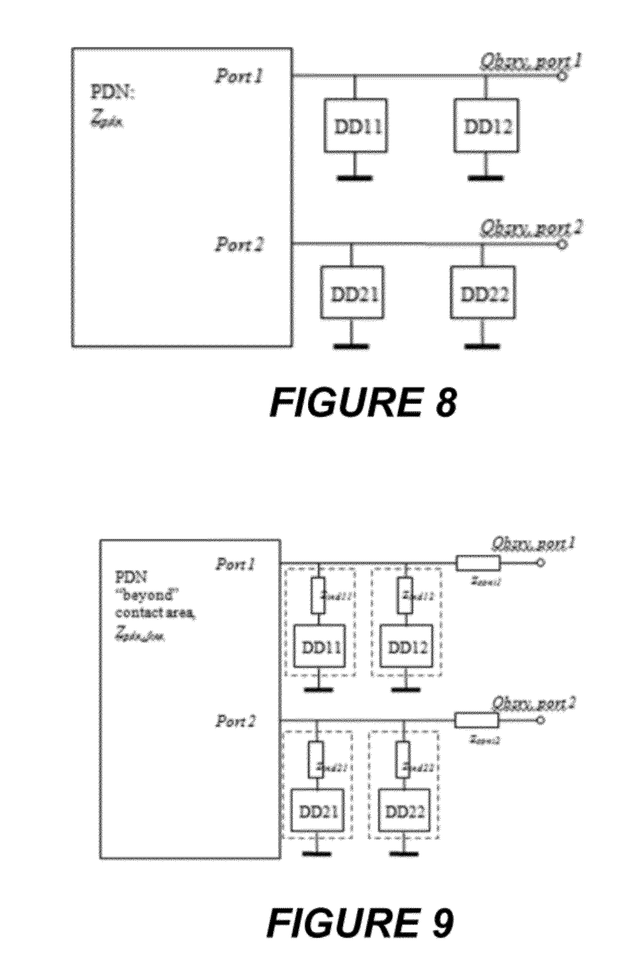

Given the shared contact and individual components of the impedance, the models of the power delivery network can be updated and the above described methods for deriving the set of decoupling devices or optimizing the set of decoupling devices can be followed. However, with directly connected decoupling devices, it is assumed that the power delivery network parameters were measured with no shared contact impedances and therefore “internal” power delivery network ports are also our observation ports. See for example, FIG. 8.

With distant placement and finite contact impedance at power pins, measured Z-parameters differ from power delivery network parameters if observed from beyond the contact area. See for example, FIG. 9. Additionally, as illustrated by FIG. 9, it is assumed that the decoupling devices are connected in series with their individual portion of impedance. In the absence of decoupling devices (i.e. those enclosed into green boxes in FIG. 9,) a simple relation between the ‘observed’ and the ‘internal’ power delivery network impedance can be shown by the following equation.

Z_{pdn}=Z_{pdn}_{_{—}}_{free}+Z_{cont} (15)

Where, Z_{pdn} is a measured power delivery network impedance matrix, Z_{pdn}_{_{—}}_{free} is an impedance matrix visible from beyond the power pin contacts, and Z_{cont} is a diagonal matrix composed from scalar contact impedances shown in FIG. 9.

Adding the decoupling, the Z-parameters as seen from observation ports become:

Z_{pdn}_{_{—dec}}=(Z_{pdn}_{_{—}}_{free}⁻¹+Y_{dec}_{_{—}}ₑₓₜᵣₐ)⁻¹+Z_{cont}. (16)

Where, Y_{dec}_{_{—}}ₑₓₜᵣₐ is a diagonal matrix, similar to Yₑₓₜᵣₐ in equation (2). Given the approximate impedance, and the decoupling impedance, Equation 16 can be represented as the following:

(Z_{pdn}_{_{—free}}⁻¹+Y_{dec}_{_{—extra}})⁻¹+Z_{cont}=Z_{T}. (17)

Given Equation (17), the diagonals of the right/left sides can be related similar to Equation (3) above. More specifically:

diag[(Z_{pdn}_{_{—free}}⁻¹+Y_{dec}_{_{—extra}})⁻¹+Z_{cont}]=diag(Z_{T}). (18)

As the contact impedance matrix is diagonal, it can be moved to the right side. Then, using Equation (15), Equation (18) can be transformed in to the following:

diag[(Z_{pdn}−Z_{cont})⁻¹+Y_{dec}_{_{—extra}}]⁻¹=diag(Z_{T}−Z_{cont}), (19)

which is that exact analog of Equation (3) above, with the only difference being that the power delivery networks Z-parameters and target impedance were updated by subtracting the contact impedances. With this modification, the procedure of finding the extra admittance detailed above, remains unchanged.

### Derivation of the Set of Decoupling Devices

Similar to that detailed above, the admittance found from (19) can be approximated by selected decoupling devices from the set of available decoupling devices. However, unlike the direct connection case above, the additional ‘individual’ impedance connected in series with the decoupling devices should be taken into account. Accordingly, the equivalent decoupling conductance of every decoupling device can be represented by the following equation:

Y_{DD}_{_{—}}_{eq}(m,l)=(Y_{DD}_{_{—}}ₘ⁻¹+z_{ind}_{_{—}}ₗ)⁻, (20)

where index m indicates the decoupling capacitor, index/stands for the placement distance and possibly for the type of mounting scheme.

In some cases, it may be convenient to consider decoupling capacitors placed at different distances as different decoupling devices (even if they were of the same type). Assuming that there exists a finite set of available capacitor types and for each such type there exists a finite set of placement distances. Different combinations (type and distance) produce larger set of available ‘devices’. They all can be pre-processed, in a way of finding properly sampled conductance, as shown by (20). Then, all such virtual devices participate in equations (5)-(7) detailed above in a similar manner as previously described.

Given this, the procedure of deriving a set of decoupling devices as detailed above, remains unchanged. However, unlike the direct connection cases, the mixed topology cases have some basic limitations. For example, series contact impedances may have considerable resistive and inductive components. To compensate for them, and lower the impedance as seen from observation ports, decoupling devices with negative ‘resistive’ and ‘inductive’ impedance can be added to the design. However, this is not possible, since all decoupling structures and the power delivery network itself is a strictly passive system. Hence, it is practically impossible to completely compensate for frequency dependent resistive losses along the current flow path.

### Decoupling Device Determination Tool

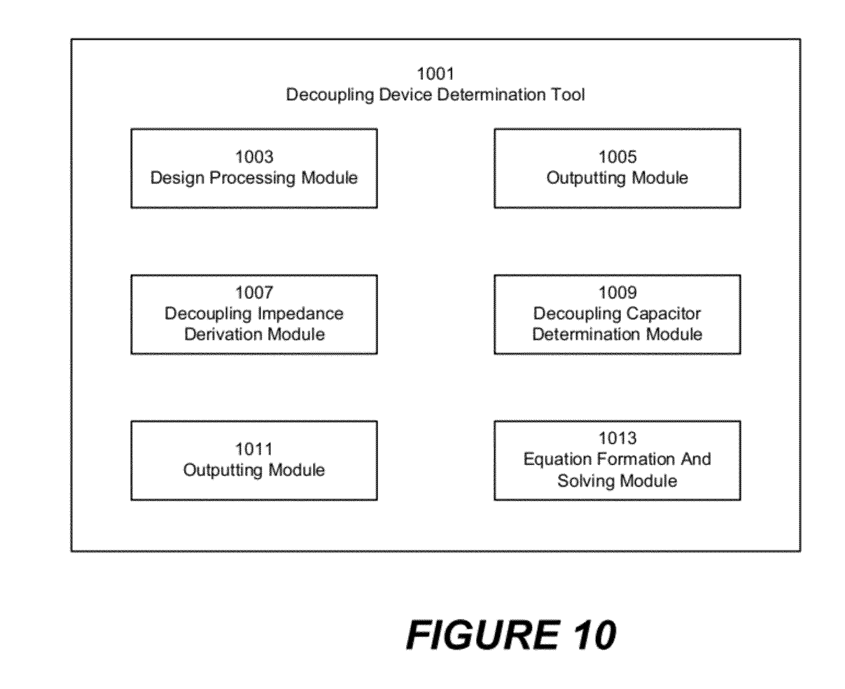

FIG. 10 illustrates a tool 1001 that may be provided by various implementations of the present invention to determine a set of decoupling devices. As can be seen from this figure, the tool 1001 includes a module 1003 for processing an electronic design. With some implementations, the module 1003 may be provided by another electronic design automation tool, such as, for example, a printed circuit board design tool. With other implementations, the module 1003 will be internal to the tool 1001 (as shown) and include the capability of accessing an electronic design, modifying the electronic design to include a set of decoupling devices, and applying various some measurement and analysis processes on the electronic design.

The tool 1001 further includes an approximate impedance determination module 1005 configured to determine the approximate impedance of the electronic design. A decoupling impedance derivation module 1007 configured to derive the decoupling impedance is also provided as well as a decoupling capacitor determination module 1009. An outputting module 1011 configured to output the set of decoupling devices as described above is provided as well.

The tool 1001 further includes a system of equations formation and solving module 1013. In various implementations, the module 1013 may be provided by an externally connected computational software package, configured to perform matrix operations and solve systems of equations.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer-implemented method for determining a configuration of components for an electronic design, the method comprising:
determining an approximated impedance value corresponding to a power delivery network of an electronic design;
deriving a decoupling impedance value that if combined with the approximated impedance value, would transform the approximated impedance value to a target impedance value;
determining a set of decoupling devices from a set of devices, that, when added to the power delivery network, form the decoupling impedance value; and
outputting the set of decoupling devices.

2. The computer-implemented method recited in claim 1, wherein the method act for outputting the set of decoupling devices includes modifying the electronic design to include the set of decoupling devices.

3. The computer-implemented method recited in claim 1, wherein the set of devices are capacitors.

4. The computer-implemented method recited in claim 1, wherein the electronic design is a design for a printed circuit board.

5. The computer-implemented method recited in claim 1, wherein the electronic design is a design for an integrated circuit.

6. The computer-implemented method recited in claim 1, further comprising determining the target impedance value for the power delivery network.

7. The computer-implemented method recited in claim 1, wherein the method act for determining a set of decoupling devices from the set of devices, that, when added to the power delivery network, form the decoupling impedance value includes:
forming a system of equations that relates the decoupling impedance value to the set of devices based in part upon the associated impedance values; and
solving the system of equations to determine a set of decoupling devices from the set of devices that form the decoupling impedance value.

8. The computer-implemented method recited in claim 1, wherein the decoupling devices are placed some distance away from the plurality of ports, and wherein deriving the decoupling impedance value comprises:
derive the parallel impedance value;
reduce the parallel impedance value to a series impedance value based on some network parameters.
